(19) United States
(12) Patent Application Publication
(10) Pub. No.: US 2026/0321789 A1
(43) Pub. Date: Oct. 15, 2026

(54) BATTERY PACK SYSTEM AND METHOD FOR MITIGATING AND RESPONDING TO THERMAL RUNAWAY

(71) Applicant: Viridi Parente, Inc., Buffalo, NY (US)

(72) Inventors: Phillip PARTIN, Grafton, MA (US); Noah S. PODOLEFSKY, Boulder, CO (US); John Paul VANCE, Amherst, NY (US); Jan-Roger LINNA, Boston, MA (US)

(73) Assignee: Viridi Parente, Inc., Buffalo, NY (US)

(21) Appl. No.: 19/652,574

(22) Filed: Apr. 20, 2026

Related U.S. Application Data
(63) Continuation of application No. 17/933,976, filed on Sep. 21, 2022, now abandoned.

(51) Int. Cl. H01M 10/6567; H01M 10/42; H01M 10/48; H01M 10/613; H01M 50/578

(52) U.S. Cl. CPC H01M 10/6567; H01M 10/425; H01M 10/48; H01M 10/613; H01M 50/578; H01M 2010/4271; H01M 2200/20

(57) ABSTRACT

Provided in this disclosure is a battery pack system including battery modules each including battery cells. An air-tight, sealed enclosure retains the battery modules. A battery manager controls operation of each of the battery modules. One or more thermal runaway shield (TRS) pouches are associated with each of the battery modules. The TRS pouches include a thermally cooling fluid that ruptures into the battery module from heat produced in a thermal runaway event in the battery module. A pressure monitoring sensor detects an increase in air pressure within the sealed enclosure associated with gas released from the thermal runaway event in the battery cells in the battery modules. A communication component transmits a pressure signal from the pressure monitoring sensor to the battery manager for implementing a subsequent management step of the battery pack system.

### I. BACKGROUND

### A. Technical Field

This invention pertains to the field of battery systems, particularly the field of mitigating thermal runaway in lithium-ion battery systems.

### B. Description of Related Art

Lithium-ion batteries have proliferated in common, everyday use. Consequently, there is an increased risk associated with thermal runaway in such batteries. Thermal runaway is an uncontrollable exothermic reaction that can occur within lithium-ion batteries when damaged or short circuited, resulting in a rapid release of heat.

During thermal runaway, the battery can rapidly reach temperatures greater than 700 °C. This heating breaks down the materials in the battery into a mixture of toxic and flammable gases. These gases could ignite and result in flames or explosion. Moreover, the heat released by the battery can propagate to any nearby batteries, resulting in a chain reaction. Systems including large stacks of batteries can suffer from a catastrophic cascade, resulting in considerable damage, pollution and potentially loss of life.

Existing battery systems are known that include a built-in fire extinguisher in the event of thermal runaway. However, such systems do not include any way of notifying service personnel that a thermal runaway event has occurred. Electronic temperature sensors cannot be implemented in a notification system since thermal runaway events are very rapid and considerable damage can quickly occur, even to such sensors and related electronics themselves, before any notifications can be received by the service personnel.

Moreover, existing battery systems are open to the ambient atmosphere and can allow toxic released gases to propagate in the work environment of service personnel. This can result in dangerous breathing harm to nearby workers.

For at least the above reasons, there is therefore a need for a battery system capable of thermal mitigation for managing and containing thermal runaway events in battery systems.

There is a specific need for a thermal mitigation system for lithium-ion battery stacks and arrays in which multiple batteries are deployed in a concentrated area.

There is also a specific need for a thermal mitigation system for lithium-ion batteries that alerts service personnel to a thermal runaway event and provides a variety of management options.

### II. SUMMARY

Provided in this disclosure is a battery pack system including a plurality of battery modules which each include a plurality of battery cells. An air-tight, sealed enclosure is provided for retaining the plurality of battery modules. A battery manager is used for controlling operation of each of the plurality of battery modules. One or more thermal runaway shield (TRS) pouches associated with each of the plurality of battery modules. Each of the TRS pouches include a thermally cooling fluid that ruptures into the battery module from heat produced in a thermal runaway event in the battery module. A pressure monitoring sensor detects an increase in air pressure within the sealed enclosure associated with gas released from the thermal runaway event in one or more battery cells of one or more battery modules. A communication component transmits a pressure signal from the pressure monitoring sensor to the power management system for implementing a subsequent management step of the battery pack system.

In another exemplary embodiment, the battery pack system can also include a vent for subsequently relieving the increase in air pressure within the sealed enclosure. The power management system can include a latching relay that deactivates the battery pack system in an event of a failure of the pressure switch or related circuit, resulting in a “fail safe” system. The subsequent management steps can include shutting down the battery pack system, alerting service personnel, recording an incident in a system log, or resetting the battery pack system.

The battery cells are preferably lithium-ion battery cells, A related method is provided of controlling thermal runaway in a battery pack system. A plurality of battery modules are provided, each including a plurality of battery cells retained in an air-tight, sealed enclosure. Operation of each of the plurality of battery modules is controlled. In a thermal runaway event occurring within one or more of the battery modules, thermally cooling fluid is ruptured from one more associated thermal runaway shield (TRS) pouches into the respective battery module from heat produced in the thermal runaway event.

An increase in air pressure is detected within the sealed enclosure associated with gas released from the thermal runaway event in the battery module. A pressure signal is transmitted for implementing a subsequent management step of the battery pack system in the controlling of the operation.

In another exemplary embodiment, the method can also include subsequently relieving the increase in air pressure within the sealed enclosure. The battery pack system can be deactivated in an event of a component failure, resulting in a “fail safe” condition. The subsequent management step can be selected from shutting down the battery pack system, alerting service personnel, recording an incident in a system log, or resetting the battery pack system. The providing of the plurality of battery cells can include providing lithium-ion battery cells.

According to an aspect of the present embodiments, a battery pack thermal mitigation system and method is provided for managing and containing thermal runaway events in lithium-ion batteries.

According to another aspect of the present embodiments, a battery pack system and method is provided for notifying service personnel that a thermal runaway event has occurred in a battery system.

According to yet another aspect of the present embodiments, a battery pack system is provided that prevents toxic gases from thermal runaway to propagate in the ambient atmosphere near service personnel, reducing danger from breathing harm to nearby workers.

Other benefits and advantages of this invention will become apparent to those skilled in the art to which it pertains upon reading and understanding of the following detailed specification.

### III. BRIEF DESCRIPTION OF THE DRAWINGS

The disclosed battery pack system may take physical form in certain parts and arrangement of parts, embodiments of which will be described in detail in this specification and illustrated in the accompanying drawings which form a part hereof and wherein:

FIGS. 1A, 1B, 1C, and 1D are respectively perspective, detail, end, and side-sectional views of a battery pack system in accordance with the present invention.

FIG. 2 is an exploded view of the battery pack system of FIGS. 1A, 1B, 1C, and 1D in accordance with the present invention.

FIGS. 3A and 3B are side views of a battery pack system including additional components in accordance with the present invention.

FIG. 4 is a schematic depicting a control scheme for the battery pack system in accordance with the present invention.

### IV. DETAILED DESCRIPTION

Reference is now made to the drawings wherein the showings are for purposes of illustrating embodiments of the article only and not for purposes of limiting the same, and wherein like reference numerals are understood to refer to like components.

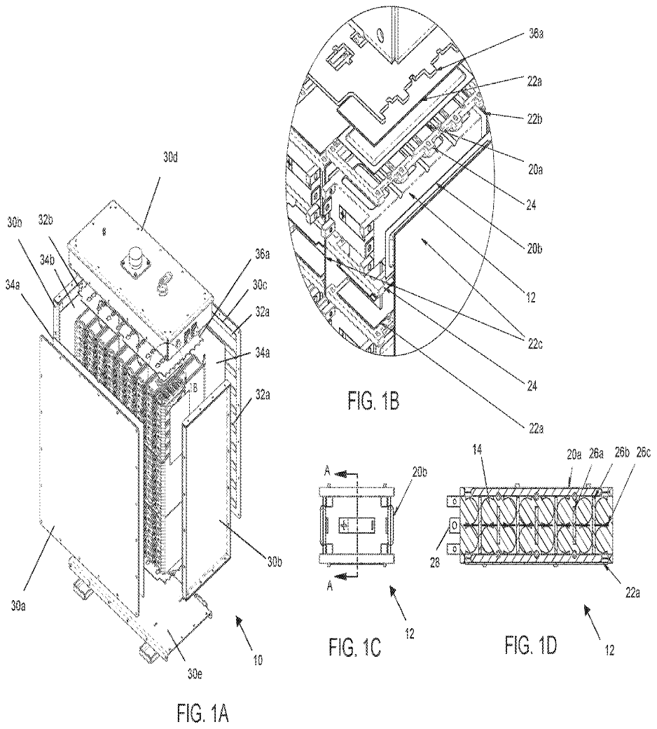

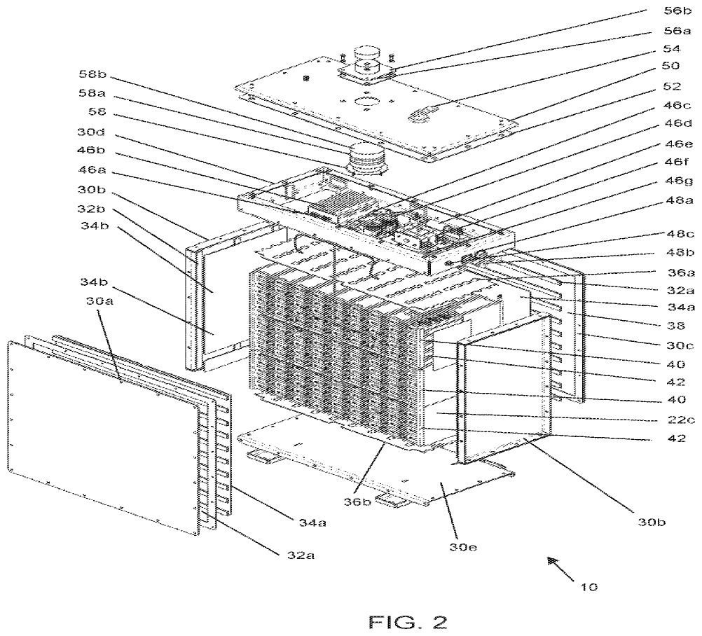

FIGS. 1A, 1B, 1C, 1D, 2, 3A, and 3B depict exemplary embodiments of the present battery pack system 10. As particularly shown in FIGS. 1A and 2, the battery pack system 10 includes a plurality of battery modules 12 assembled into an array and retained inside a housing (as discussed in detail hereinbelow). FIG. 1A includes a circular callout 1B which is shown in detail in FIG. 1B and depicts the battery modules 12 in place within the array. FIG. 1D indicates a cross-section of the module 12 along the line A-A shown in the end view of FIG. 1C and shows that each battery module 12 includes a plurality of battery cells 14. In the preferred embodiment, the battery modules 12 are composed of a plurality of lithium-ion battery cells and are of the same design and configuration as the battery modules disclosed in the commonly assigned, co-pending patent application (Attorney Docket No. 42544.50030) entitled STACKING FRAME AND COOLING SYSTEM FOR BATTERY CELLS, the entirety of the disclosure of which is hereby incorporated by reference.

With particular reference to FIGS. 1B, 1C, and 1D, one or more thermal runaway shield (TRS) pouches 20a, 20b are associated with each of the plurality of battery modules 12. The TRS pouches 20a, 20b each include a thermally cooling fluid that ruptures into the associated respective battery module 12 from heat produced in a thermal runaway event in the battery module 12. A side pouch 20a can be provided over the horizontal top and/or bottom surfaces of a module 12, and an end pouch 20b can be provided over one or both of the vertical side surfaces of the module 12. The TRS pouches 20a, 20b are preferably coated aluminum pouches that include a thermally cooling fluid that ruptures into the battery module from heat produced in a thermal runaway event in the battery module 12. In one exemplary embodiment of the invention, the TRS pouches are of a type manufactured by KULR Technology Group, Inc., as also disclosed in the aforementioned commonly assigned patent application. Upon rupturing, the pouches 20a, 20b release the thermally cooling fluid composed of a water-based coolant having known properties that safely extinguish flame and absorb heat in a lithium-ion battery. In this manner, the present passive cooling system is an anti-propagation system that extinguishes thermal runaway in a single battery module 12 and thereby protects any nearby battery modules 12 from thermal runaway thus preventing a dangerous cascade situation.

With continuing reference to FIG. 1B, 1C, and 1D, the battery modules 12 and the TRS pouches 20a, 20b are separated by one or more plates or sheets 22a, 22b, 22c inserted therebetween, so that the sheets 22a, 22b, 22c divide and separate the TRS pouches 20a, 20b. A top/bottom sheet 22a is horizontally provided between each of the vertically stacked modules 12. A mid sheet 22b is vertically provided in between the back ends of the modules 12 stacked within the array. An end sheet 22c is vertically provided along the sides of the modules 12 stacked within the array. In this manner, the sheets 22a, 22b, 22c provide thermal barriers between the TRS pouches 20a, 20b during the thermal runaway event in a battery module 12.

The sheets 22a, 22b, 22c are formed of a suitably heat resistant material such as phenolic having known properties that contain the heat, as also disclosed in the aforementioned commonly assigned patent application. The sheets 22a, 22b, 22c can allow one of the TRS pouches 20a, 20b to rupture and quench the battery module 12 but can protect another of the TRS pouches 20a, 20b from prematurely rupturing unless the heat in the battery module 12 is sufficiently high that a second pouch is required to extinguish the flame. Thus, the sheets 22a, 22b, 22c only allow a sufficient amount of cooling fluid to be released without wasting.

FIG. 1B also shows the stacking frames 24. As also described in the aforementioned commonly assigned patent application, the stacking frames 24 are all formed of the same basic stacking frame design. Thus, the stacking frames 24 are identical and interchangeable with each other, both having features of the same stacking frame 24 that are interoperable and interconnectable. The stacking frame 24 includes a peripheral frame portion that is configured to sit atop a perimeter of the surface of the battery module 12. As shown, the peripheral frame portion is generally rectangular and is defined by a solid frame having frame members parallel, opposite, and identical to each other, where the peripheral frame portion is generally open or void in a central area within the periphery of the frame structure.

As depicted in FIG. 1D, each of the battery modules 12 also include additional phenolic members 26a, 26b, 26c that provide additional separation and protection between each of the battery cells 14. A short vertical member 26a alternates with long vertical members 26b and are perpendicularly oriented with respect to horizonal members 26c, in order to provide an additional measure of thermal protection around each individual battery cell 14. Each of the modules 12 include electrical connections 28 that enable an exchange of electrical power for alternately charging and discharging each module 12. These electrical connections 28 enable individual control over each module 12 by a battery manager (discussed below) and connect to a bus for supplying power, using commonly available mating electrical connections as understood by those having skill in the art.

With reference to FIGS. 1A, 2, 3A, and 3B, the present battery pack system 10 includes an air-tight, sealed enclosure 30 for retaining the plurality of battery modules 12. The enclosure 30 includes a front plate 30a, side plates 30b, a back plate 30c, a top plate 30d, and a bottom plate 30e, thereby enclosing the array of battery modules 12. Cover strips 32a are mounted in horizontal rows along the interior surface of the front plate 30a and back plate 30c. Side strips 32b are mounted in vertical rows along the interior surface of the side plates 30b.

Sides 34a, 34b are retained on the interiors of the front plate 30a, side plates 30b, and back plate 30c. Spacers 36a, 36b are retained on the top and bottom of the array of modules 12. The cover strips 32a and side strips 32b are preferably foam strips that cooperate together with the sides 34a, 34b which are plastic sheets to keep the module stacks under compression. The spacers 36a, 36b are phenolic sheets used as part of the anti-propagation system as a thermal barrier and ablative material (which absorbs heat via combustion and decomposes into carbon). Cover gaskets 38 are provided around the periphery of the front plate 30a, side plates 30b, back plate 30c, top plate 30d, and bottom plate 30e for providing an air-tight seal around the entirety of the enclosure 30.

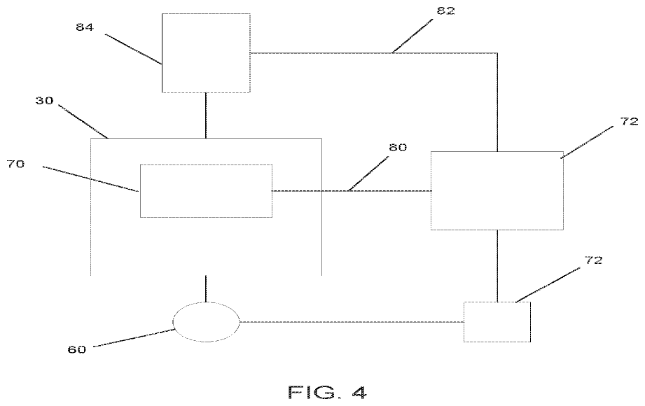

With continued reference to FIGS. 1A, 2, 3A, and 3B, the present battery pack system 10 has electrical conductors including bus bars 40 with bus bar covers 42 and a copper braid (not shown) for cooperating with the electrical connections 28 in a conventional manner to enable the exchange of electrical power for alternately charging and discharging each module 12 in the array. The copper bus bars 40 are used to retain five modules 12 in a parallel orientation and provide a series electrical connection to the next row of five modules above or below. The copper braid it used to connect the modules 12 in series from the modules 12 from the one side to the other side. As shown in the drawing, there are two vertical stacks of modules in the foreground and background. The top plate 30d encloses the electronics components of the battery pack system 10. These conventional components include a battery harness 46a, battery management system 46b, cell tap harness 46c, contactor 46d, fuse 46e, disconnect switch 46f, and Hall effect current sensor 46g. The outer edge of the top plate 30d includes a positive receptacle 48a, HVDC (High Voltage Direct Current) connection 48b, and a socket flange 48c. The HVDC connection 48a connects to the positive side of the battery pack. Next to it is an HVDC connection for the negative side. Dust caps are used during transportation only to keep the connectors sealed from dust and moisture. The socket flange 48c connects the battery pack to 24 VDC to power the BMS. The socket flange 48c also provides an external CANBUS communication connection 80 from the battery pack to an external PMS (Power Management System) which controls the battery pack and an external power converter (inverter) 84, connected via a MODBUS 82 (FIG. 4). In some embodiments, configurations are employed where multiple battery packs can be connected in series so that the same connector provides communications link to the remote battery pack BMS.

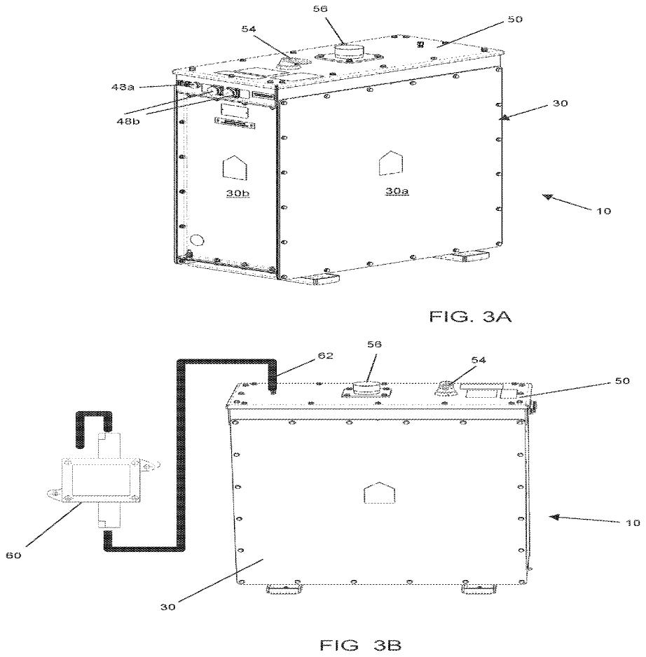

Referring now to FIGS. 2, 3A and 3B, an electronics cover plate 50 is provided to enclose the top plate 30d with the electronics components. An electronics lid gasket 52 seals the volume enclosing the aforementioned electronics components. A disconnect handle 54 is used to attach and remove the cover plate 50. A plastic vent cap 56 is provided for venting the interior of the enclosure 30 in the event of an explosion resulting from a thermal runaway event. The vent pipe with mounting flange 56b and seal 56a are connected to flame arrestor backer plate 58 with associated mesh 58a and gauze 58b. In this manner, the vent cap 56 and related structures provide a vent for subsequently relieving the increase in air pressure within the sealed enclosure associated with the thermal runaway event.

As particularly shown in FIG. 3B, the enclosure 30 includes one or more pressure monitoring switches 60 for detecting an increase in air pressure within the sealed enclosure associated with gas released from the thermal runaway event in one or more of the battery cells 14 in one or more of the battery modules 12. A port 62 is formed within the enclosure 30 and in fluid communication with the interior of the enclosure 30. The port 62 is fluidly connected to the pressure monitoring sensor for transmitting a pressure spike from an explosion resulting from a thermal runaway event in one of the modules 12. In the preferred embodiment, the pressure switches 60 can be the Dwyer Series 1950, explosion-proof differential pressure switches sold by Dwyer Instruments, Inc. of Michigan City, Indiana, preferably a Dwyer 1950P-2-2F or an-Omega PSW-152 sold by Omega Engineering Inc. of Norwalk, Connecticut. Both pressure switches have LOW-and HIGH-pressure ports. The HIGH-pressure port is connected to the battery pack lid via copper tubing and the LOW-pressure port is left open to atmospheric pressure.

With specific reference to FIG. 4, the pressure monitoring switch 60 is in communication with a battery manager 70 that controls the operation of each of the plurality of battery modules 12, enabling each module 12 to be selectively activated and deactivated. The battery manager 70 has a control connection established with each module 12 in the array 12a, within the enclosure 30. A thermal runaway event in a single lithium-ion cell can instantly generate 2-4 liters of gas inside the sealed enclosure 30. This results in an instantaneous spike in pressure that is readily detected by the pressure switch 60. Test results indicate capture of any average pressure change of 1.55 psig, which may be attributed to a sampling rate of a DAQ (Data Acquisition system) and/or the responsiveness of the pressure sensor. Preferably, a pressure switch calibrator is used to set the pressure switch 60 to trigger at 0.5 psig and test each sensor three times to confirm the setting.

With continued reference to FIG. 4, the switch 60 cooperates with a communication component 72 for transmitting a pressure signal from the pressure monitoring switch 60 to the power manager system (PMS) 70 for implementing a subsequent management step of the battery pack system 10. The BMS 70 monitors the “cell” voltage of each five modules connected in parallel and also monitors the actual cell temperature in eight modules via thermistors spread throughout the battery pack. The BMS 70 is also used to sense change in the “cell” voltage due to a thermal event but that event would need to generate a sustained short circuit to pull the voltage down enough for the BMS 70 to detect that there was an issue.

Likewise, a TR event will generate significant amount of heat but if the failing cell is located in a location far away from the eight thermistors it may take time for the heat to reach one of BMS thermal thermistors.

Subsequent to detecting the pressure signal, the power management system 72 can then perform one or more management steps in response to the detected thermal runaway event. The power management system 72 can shut down the battery pack system 10 altogether. Alternately or in addition, the power management system 72 can alert service personnel to take direct action, and/or it can record an incident in a system log, and/or it can initiate a resetting of the battery pack system 10. Additionally, the power management system 72 includes a latching relay that deactivates the battery pack system 10 in an event of pressure switch 60 activation or connection failure resulting in a “fail safe” system. The pressure switches 60 have NC (Normally Closed) contacts. A relay is wired in such a way to make a NC series circuit with the pressure switch 60. It is considered a “fail safe” system since a break in the series circuit (ex. A cut wire) or a failure of the relay or the power supply it will cause the NC series to fail OPEN.

As described hereinabove, the apparatus of the present invention enables the performance of a method of controlling thermal runaway in a battery pack system 10. Such a method includes providing a plurality of battery modules 12 each including a plurality of battery cells 14 (preferably lithium-ion battery cells) retained in an air-tight, sealed enclosure 30. A step is performed of controlling operation of each of the plurality of battery modules 12. Upon occurrence of a thermal runaway event within at one or more of the battery modules 12, an automatic step is performed of rupturing thermally cooling fluid one or more associated thermal runaway shield (TRS) pouches 20a, 20b into the respective battery module(s) 12 from heat produced in the thermal runaway event. A subsequent step is performed of detecting an increase in air pressure within the sealed enclosure 30 associated with gas released from the thermal runaway event in the battery module(s) 12. After that, a step is performed of transmitting a pressure signal for implementing a subsequent management step of the battery pack system 10 in the controlling of the operation.

The method can include an additional step of subsequently relieving the increase in air pressure within the sealed enclosure. The method can also include deactivating the battery pack system 10 in an event of a component failure, resulting in a “fail safe” condition. One or more subsequent management steps can include shutting down the battery pack system, alerting service personnel, recording an incident in a system log, and/or resetting the battery pack system.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A battery pack system, comprising:
a plurality of battery modules each comprising a plurality of battery cells;
an air-tight, sealed enclosure for retaining the plurality of battery modules;
a battery manager for controlling operation of each of the plurality of battery modules;
at least one thermal runaway shield (TRS) pouch associated with each of the plurality of battery modules, the at least one TRS pouch including a thermally cooling fluid that ruptures into the battery module from heat produced in a thermal runaway event in the battery module;
a pressure monitoring sensor for detecting an increase in air pressure within the sealed enclosure associated with gas released from the thermal runaway event in at least one of the battery cells in at least one of the battery modules; and
a communication component for transmitting a pressure signal from the pressure monitoring sensor to the battery manager for implementing a subsequent management step of the battery pack system.

2. The battery pack system of claim 1, further comprising a vent for subsequently relieving the increase in air pressure within the sealed enclosure.

3. The battery pack system of claim 1, wherein the battery manager comprises a latching relay that deactivates the battery pack system in an event of a component failure, resulting in a “fail safe” system.

4. The battery pack system of claim 1, wherein the subsequent management step is selected from at least one of: shutting down the battery pack system; alerting service personnel; recording an incident in a system log; or resetting the battery pack system.

5. The battery pack system of claim 1, wherein the plurality of battery cells are lithium ion battery cells.

6. A method of controlling thermal runaway in a battery pack system, comprising:
providing a plurality of battery modules each comprising a plurality of battery cells retained in an air-tight, sealed enclosure;
controlling operation of each of the plurality of battery modules;
in a thermal runaway event within at least one of the battery modules, rupturing thermally cooling fluid from at least one associated thermal runaway shield (TRS) pouch into the respective at least one battery module from heat produced in the thermal runaway event;
detecting an increase in air pressure within the sealed enclosure associated with gas released from the thermal runaway event in the at least one battery module; and
transmitting a pressure signal for implementing a subsequent management step of the battery pack system in the controlling of the operation.

7. The method of claim 6, further comprising subsequently relieving the increase in air pressure within the sealed enclosure.

8. The method of claim 6, further comprising deactivating the battery pack system in an event of a component failure, resulting in a “fail safe” condition.

9. The method of claim 6, wherein the subsequent management step is selected from at least one of: shutting down the battery pack system; alerting service personnel; recording an incident in a system log; or resetting the battery pack system.

10. The method of claim 5, wherein the step of providing the plurality of battery modules each comprising the plurality of battery cells includes providing lithium ion battery cells.
